(19) United States
(12) Patent Application Publication
(10) Pub. No.: US 2016/0279630 A1
(43) Pub. Date: Sep. 29, 2016

(54) Methods and Apparatus for Pipetting

(71) Applicant: Massachusetts Institute of Technology, Cambridge, MA (US)

(72) Inventors: Charles Fracchia, Cambridge, MA (US); Matthew Carney, Brookline, MA (US); Joseph Jacobson, Newton, MA (US); Jason Fischman, Boston, MA (US)

(21) Appl. No.: 15/083,706

(22) Filed: Mar. 29, 2016

Related U.S. Application Data
(60) Provisional application No. 62/139,746, filed on Mar. 29, 2015.

(51) Int. Cl. B01L 3/02; G01N 1/28

(52) U.S. Cl. CPC B01L 3/0217; G01N 1/28; B01L 2400/0487; B01L 2200/0605; B01L 2300/0864; B01L 2300/0832; B01L 2300/0627

(57) ABSTRACT

A pipetting system identifies and records data regarding pipetting events, including the time and well into which a pipette dispenses liquid and the volume of liquid dispensed into the well. The pipetting system also measures and records other data regarding the context of pipetting events. This other data includes the speed of pipetting, the pressure exerted on a plunger of the pipette by a finger of a user, and the temperature, humidity and lighting conditions at a well tray into which the liquid is dispensed. The pipetting system includes a pipette that has multiple cylinders and multiple corresponding pistons. Each cylinder has different diameter. Thus, a down-stroke of the pistons causes each of the cylinders to expel a different amount of air. A rotatable mechanism selects which cylinder is connected by an airway to a pipette tip and which other cylinders vent directly to the ambient atmosphere.

### RELATED APPLICATIONS

This application is a non-provisional of, and claims the benefit of the filing date of, U.S. Provisional Patent Application No. 62/139,746, filed Mar. 29, 2015, the entire disclosure of which is herein incorporated by reference.

### FIELD OF TECHNOLOGY

The present invention relates generally to pipetting.

### SUMMARY

In illustrative implementations of this invention, a pipetting system identifies and records data regarding pipetting events, including the time and well into which a pipette dispenses liquid and the volume of liquid dispensed into the well. The pipetting system also measures and records other data regarding the context of pipetting events. This other data includes the speed of pipetting, the pressure exerted on a plunger of the pipette by a finger of a user, and the temperature, humidity and lighting conditions at a well tray into which the liquid is dispensed. The pipetting system accepts input from a user, such as text or oral annotations regarding pipetting events.

In illustrative implementations, the pipetting system includes a multi-cylinder pipette that dispenses a wide range of liquid volumes. For example, in some cases, a single pipette dispenses a volume of liquid over a wide range from 0.2 microliters to 1000 microliters. This is advantageous compared to a conventional pipette system, which requires multiple different pipettes—each a different size—in order to dispense liquid over such a wide range of volumes.

In illustrative implementations, the pipette has multiple cylinders and multiple corresponding pistons. Movement of a shaft causes the multiple pistons to move simultaneously. Each cylinder has different diameter. Thus, a down-stroke of the pistons causes each of the cylinders to expel a different amount of air.

In illustrative implementations, a rotatable mechanism selects which cylinder is connected by an airway to a pipette tip and which other cylinders vent directly to the ambient atmosphere. The different airways have different diameters. The different diameters of the airways tend to equalize air pressure in the different-sized cylinders during a down-stroke of the pistons.

In some cases, movement of the pistons is actuated by force exerted by a user on a plunger of the pipette. In other cases, movement of the pistons is actuated by a motor onboard the pipette.

In illustrative implementations, the volume of air displaced from a cylinder during a piston down-stroke—and thus the volume of liquid dispensed from a pipette tip of the pipette—is fine-tuned by adjusting the range of motion of the pistons. For example, in a pipette with a user-actuated plunger, a motor may adjust the position of a mechanical stop that limits the range of motion of the plunger. Or, in other cases, the operation of a motor that actuates the pistons may be controlled so as to adjust their range of motion.

In illustrative implementations, a linkage system transmits force from a shaft to the pistons. In some cases, the linkage system includes spokes that radiate from the end of the shaft and that lie in a geometric plane that is perpendicular to the shaft. The spokes are of unequal length. Each piston is attached at an outer end of a spoke, one piston per spoke. The different lengths of the spokes are such that, during a downstroke, the magnitudes of the torques exerted by the pistons on the spokes are substantially equal to each other. This is advantageous, because if the torques were unequal, the unequal torques would tend to cause the shaft or pistons to bend slightly and thus to jam or move jerkily, interfering with accurate dispensing of liquid.

In some cases, the linkage system has a compact configuration that includes a set of concentric rings. Each ring in the set transmits force to a single piston. Specifically, for each ring in the set, a small plate transmits force from the shaft to the ring, and the ring in turn transmits force to its corresponding piston. The surface areas of the plates differ from each other. Likewise, the surface areas of the rings differ from each other. The different-sized rings transmit different amounts of force to the pistons of the different-sized cylinders, thereby distributing the forces in a balanced manner.

A wide variety of linkage systems may be used, including linkage systems that emulate the effect of a whippletree.

In illustrative implementations, one or more sensors provide feedback that helps control the operation of the pipette or pipetting system. For example, in some cases, a pressure sensor at the top of a plunger gathers data regarding the pressure exerted by a user on the plunger of the pipette. The pressure data is used to control the “stiffness” of pipette (e.g., how much work it takes to push the plunger down).

In illustrative implementations, the context-aware pipetting system includes wireless communication modules. Different components of the system communicate wirelessly with each other in order to track pipetting events and their context.

The context-aware pipetting system has many practical advantages. The contextual data that is gathered may be analyzed for many purposes, such as to detect correlations that would not otherwise be apparent, to determine optimal procedures or optimal conditions, and to provide feedback and training to users of the pipetting system.

In conventional labs, many experiments involving pipetting are repeated unnecessarily, because insufficient data is recorded during each experiment. In contrast, in illustrative implementations of this invention, the system records voluminous data regarding pipetting events and their context. This data may be analyzed in real time or later off-line, thereby avoiding the need for repeating some procedures.

The description of the present invention in the Summary and Abstract sections hereof is just a summary. It is intended only to give a general introduction to some illustrative implementations of this invention. It does not describe all of the details and variations of this invention. Likewise, the description of this invention in the Field of Technology section is not limiting; instead it identifies, in a general, non-exclusive manner, a technology to which exemplary implementations of this invention generally relate. Likewise, the Title of this document does not limit the invention in any way; instead the Title is merely a general, non-exclusive way of referring to this invention. This invention may be implemented in many other ways.

### BRIEF DESCRIPTION OF THE DRAWINGS

FIGS. 1A and 1B each show a pipette with multiple cylinders, where each cylinder in the pipette has a different volume. In FIG. 1A, motion of pistons in the cylinders is actuated by a user pressing against a plunger. In FIG. 1B, motion of pistons in the cylinders is actuated by an electric motor.

FIG. 2 shows pistons and corresponding cylinders of a pipette.

FIG. 3A shows radial components for transmitting force to the pistons.

FIG. 3B shows concentric rings for transmitting force to the pistons.

FIG. 3C shows another version of a pipette with multiple cylinders, where each cylinder in the pipette has a different volume.

FIG. 4 shows air channels in a pipette.

FIG. 5A, FIG. 5B, FIG. 5C and FIG. 5D each show a different view of a region of a pipette. The region is penetrated by air channels.

FIG. 5E shows an example in which the cylinders each have a different diameter and the airways each have a different diameter.

FIG. 6A shows a sensor for detecting pressure exerted against the plunger by a user's thumb.

FIG. 6B shows sensors that measure speed or velocity of pipetting.

FIG. 7 shows a context-aware pipetting system.

FIGS. 8A and 8B show wells in a portion of a well tray. In FIG. 8A, the wells have fiducial visual marks. In FIG. 8B, the wells do not have fiducial visual marks.

FIG. 9 is a flow-chart for assigning addresses to wells in an image of a well plate.

FIG. 10 is a flow-chart for a pipette detecting and reporting its state.

FIG. 11A is a flow-chart for a sensor providing feedback to a pipette.

FIG. 11B is a flow-chart for a pressure sensor providing feedback to a pipette.

The above Figures show some illustrative implementations of this invention, or provide information that relates to those implementations. However, this invention may be implemented in many other ways.

### DETAILED DESCRIPTION

Dispensing Wide Range of Liquid Volumes with a Single Pipette

In illustrative implementations of this invention, a single pipette may dispense a wide range of volumes of liquids. For example, in some cases, a single pipette dispenses a volume of liquid over a wide range from 0.2 microliters to 1000 microliters. This is advantageous compared to a conventional pipette system, which requires multiple different pipettes—each a different size—in order to dispense liquid over such a wide range of volumes.

In illustrative implementations of this invention, the wide range of a single pipette is achieved as follows: The single pipette includes multiple cylinders. Each cylinder has a different volume. In addition, the single pipette is configured to be attached to different sized pipette tips. Furthermore, the range of motion of the piston of each cylinder is adjustable.

To select a particular volume of liquid to dispense, a user attaches an appropriately sized pipette tip to the bottom of the pipette, and provides input that selects an appropriately sized cylinder.

In some cases, a user fine-tunes the volume to be dispensed by also adjusting the range of motion of a shaft that drives motion of the pistons. For example, in some cases the range of motion is controlled by adjusting the position of a mechanical stop. The stop limits the range of motion of a user-actuated plunger attached to the shaft. In other cases, the shaft is actuated by a motor and the range of motion of the shaft is directly controlled by the motor.

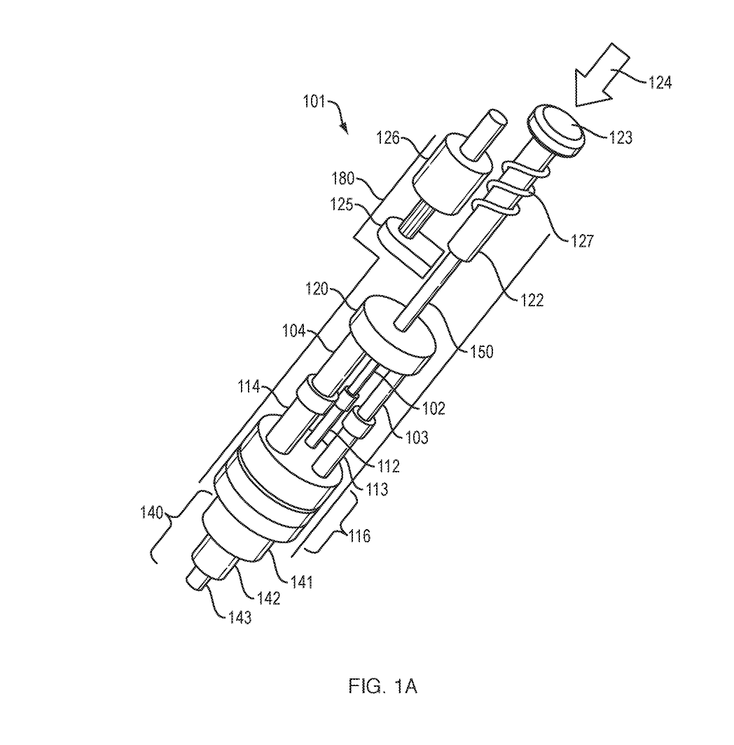

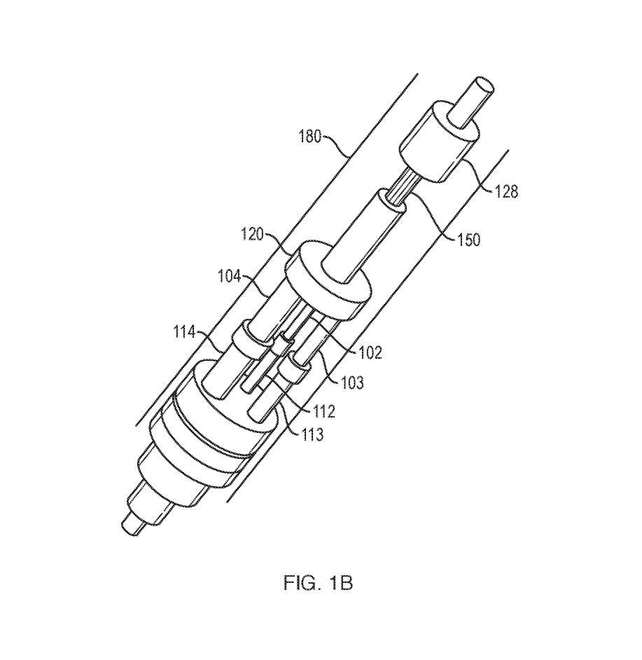

FIGS. 1A and 1B each show a pipette with multiple cylinders. Each cylinder has a different volume. The range of motion of the piston for each cylinder is adjustable. Thus, when pistons move inside the different cylinders, different volumes of air move into or out of the cylinders. Whether air moves into or out of the cylinders depends on the direction of movement of the pistons.

A selection mechanism selects which cylinder is being used. An airway connects the selected cylinder with the pipette tip. If the pipette tip is immersed in liquid and the piston of the selected cylinder moves up, then air moves up through the airway into the selected cylinder, and liquid moves up into the pipette tip. The diameter of the cylinder and the range of motion of the piston determine the volume of air that moves into the selected cylinder—and thus the volume of liquid that moves up into the pipette tip.

Likewise, if liquid is inside the pipette tip and the piston of the selected cylinder moves down, then air is displaced from the selected cylinder and moves down the airway into the pipette tip, causing a volume of liquid to be ejected from the pipette tip. The diameter of the cylinder and the range of motion of the piston determine the volume of air that moves out of the selected cylinder—and thus the volume of liquid that is dispensed from the pipette tip.

Motion of the shaft causes the pistons of all of the cylinders to move simultaneously. However, only the selected cylinder is connected by an airway to the pipette tip. The non-selected cylinders are connected to airways that vent directly to the ambient atmosphere, without passing through a pipette tip. Thus, when pistons of the non-selected cylinders move down, they displace air out through the vent channels to the ambient atmosphere. When pistons of the non-selected cylinders move up, they draw air through the vent channels, from the ambient atmosphere into the non-selected cylinders.

In FIG. 1A, motion of pistons in the cylinders is actuated by a user pressing against a plunger. In FIG. 1B, motion of pistons in the cylinders is actuated by an electric motor.

In FIGS. 1A and 1B, the pipette 101 includes three pistons 102, 103, 104 and three corresponding cylinders 112, 113, 114. The volume of the internal chamber of cylinder 112 is smaller than the volume of the internal chamber of cylinder 113, which in turn is smaller than the volume of the internal chamber of cylinder 114. A linkage system inside component 120 transmits force from a shaft 150 to the pistons.

In FIGS. 1A and 1B, the pipette includes an external housing 180.

In FIG. 1A, the plunger 122 is actuated by force 124 exerted by a human user against a broad flange 123 at the top end of the plunger 122.

In FIG. 1, a mechanical stop 125 and the plunger 122 are configured such that stop 125 limits the range of motion of plunger 122. This is achieved as follows: The main body of plunger 122 is wider than a shaft 150 attached to the bottom of the plunger. The stop 125 is positioned such that shaft 150 moves unimpeded past stop 125, but stop 125 blocks the plunger 122 from moving past stop 125. A spring 127 is wound around plunger 122. Spring 127 is unable to move past stop 125. Thus, as the plunger moves downward, spring 127 compresses. When the user moves his or her finger away from the plunger, the compressed spring tends to move the plunger 122 upward until the spring is no longer compressed.

In FIG. 1A, the position of stop 125 is controlled by a motor 126.

In FIG. 1B, the plunger 122 is actuated by a motor 128.

In some cases, the motor 126 or motor 128 comprises a servo motor or stepper motor.

In FIGS. 1A, 1B, 3C, and 4, an attachment site is configured to hold multiple different sizes of pipette tips. An attachment site 140 comprises three annular regions 141, 142, 143. Each pipette tip has an overall shape that approximates a truncated cone. The wide end of the pipette tip fits snugly around one of these annular regions 141, 142, 143, thereby holding the pipette tip in place at the bottom of the pipette. The three annular regions 141, 142, 143 of the attachment site 140 have different diameters and thus hold different size pipette tips. Specifically, region 141 has a greater diameter than region 142, which in turn has a greater diameter than region 143. Thus, the pipette tips that attach to region 141 have a greater diameter than the pipette tips that attach to region 142. Likewise, the pipette tips that attach to region 142 have a greater diameter than the pipette tips that attach to region 143. In most cases, only one pipette tip at a time is attached to the attachment site 140.

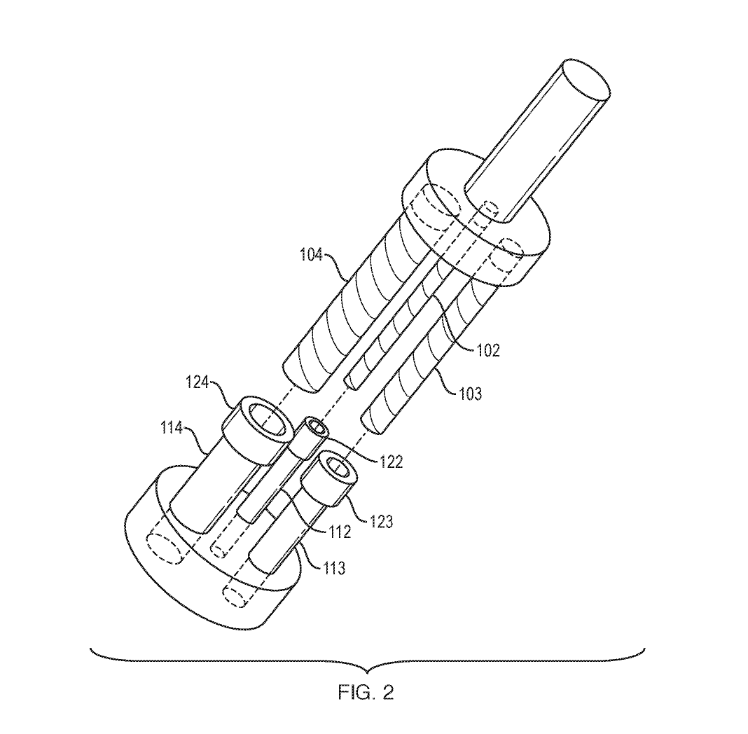

FIG. 2 shows three pistons 102, 103, 104 and three corresponding cylinders 112, 113, 114 of a pipette. Cylinders 112, 113, 114 have caps 122, 123, 124, respectively. Each cap contains an O-ring. The O-ring for a cylinder creates a seal around the piston for that cylinder.

### Transmission of Force to Pistons

In illustrative implementations, transmission of forces to the pistons may be achieved in different ways.

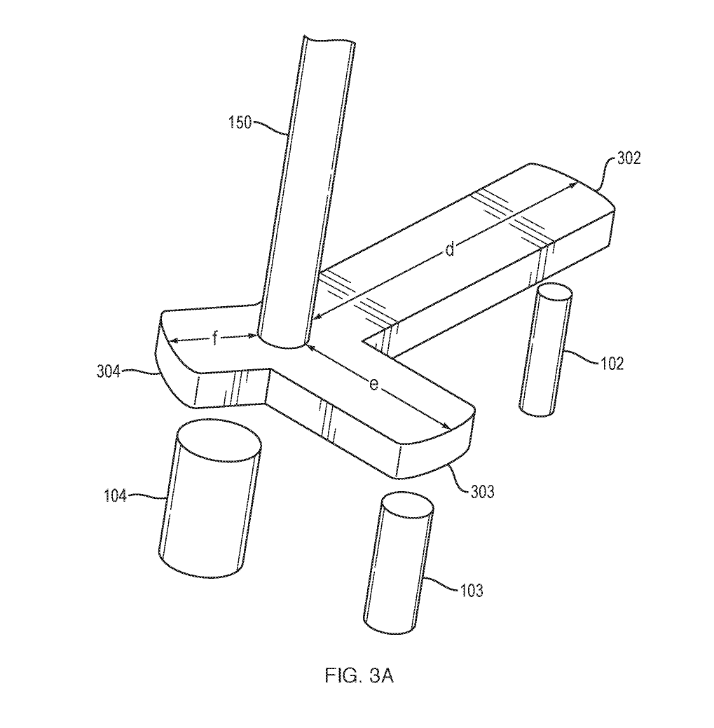

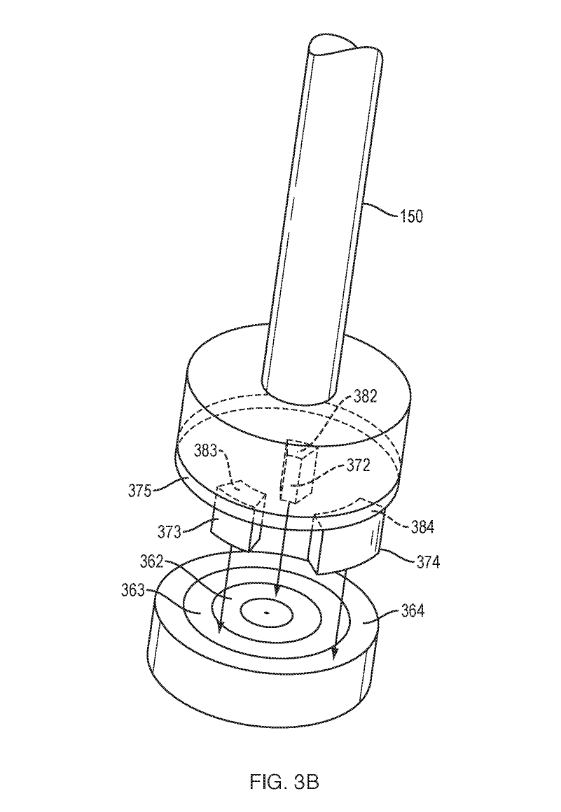

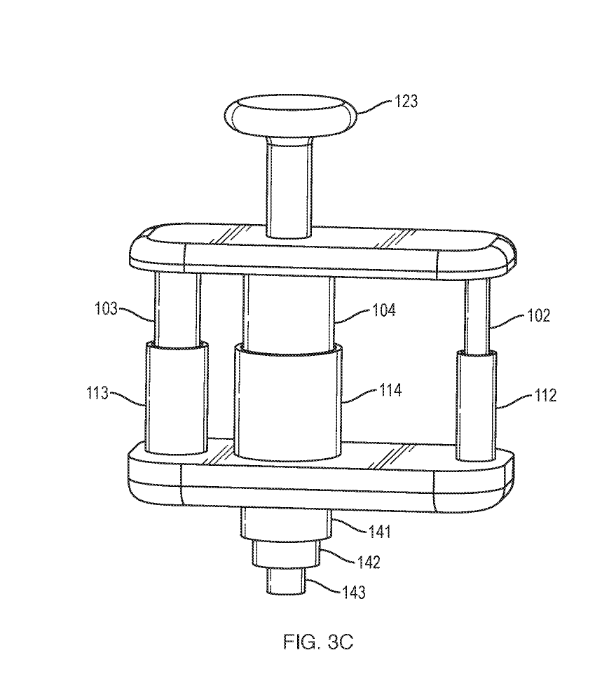

In some cases, a radial linkage system transmits forces from the shaft to the pistons. Each radial structural element (hereinafter, “spoke”) of this linkage system transmits force from shaft 150 to a particular piston. For example, in FIG. 3A: spoke 302 transmits force from shaft 150 to piston 102; spoke 303 transmits force from shaft 150 to piston 103; and spoke 304 transmits force from shaft 150 to piston 104.

In FIG. 3A, the spokes have different lengths. Spoke 302 has length d, spoke 303 has length e, spoke 304 has length f, and d>e>f. The different lengths tend to equalize the magnitude of the torques exerted by the pistons on the spokes. This is desirable for the following reason: The different-sized pistons displace different volumes of air while moving, and thus are opposed by different magnitude forces when displacing the air. If each of the spokes were the same length, then the magnitude of the torques exerted by the pistons on the spokes would be different. These different magnitudes of torque would tend to bend the shaft 150 or a plate attached to the shaft, thereby causing the shaft/piston system to move jerkily or jam, and to cause inaccurate dispensing of liquids. The different length spokes tend to equalize the torques, and thus to prevent jamming or jerky (e.g., slip-stick) motion of the pistons.

FIG. 3B shows an alternative implementation, in which three concentric rings 362, 363, 365 transmit force to pistons 102, 103, and 104, respectively. An advantage of the configuration shown in FIG. 3B is that it is spatially compact. In FIG. 3B, three actuator parts 372, 373, 374 are attached at one end to concentric rings 362, 363, 364 respectively and at the other end to a plate 375, which is in turn attached to shaft 150. Thus: actuator part 372 transmits force from plate 375 to piston 102; actuator part 373 transmits force from plate 375 to piston 103; and actuator part 374 transmits force from plate 375 to piston 104.

In FIG. 3B, the top surfaces 382, 383, 384 of these three actuator parts 372, 373, 374 differ in area: the area of top surface 382 is smaller than the area of top surface 383, which is in turn smaller than the area of top surface 384. In some implementations, the same pressure (force per unit area) is applied to each of these top surfaces during a downward movement of the shaft 150, but the different areas of these top surfaces cause different total amounts of force to be applied to the different pistons. Thus, for example, a larger total force is applied to top surface 384 than to top surface 382. This is desirable because a larger total force is needed to displace the larger volume of air from the larger cylinder 114, and a smaller total force is needed to displace the smaller volume of air from the smaller cylinder 112.

FIG. 3C shows another version of a pipette with multiple cylinders, where each cylinder in the pipette has a different volume. In the example shown in FIG. 3C, the cylinders are arranged in a row.

### Selection Mechanism

In illustrative implementations of this invention, rotatable components that are penetrated by airways are used to select which cylinder of the pipette has an airway connection to the pipette tip, and which other cylinder(s) of the pipette vent directly to the ambient atmosphere.

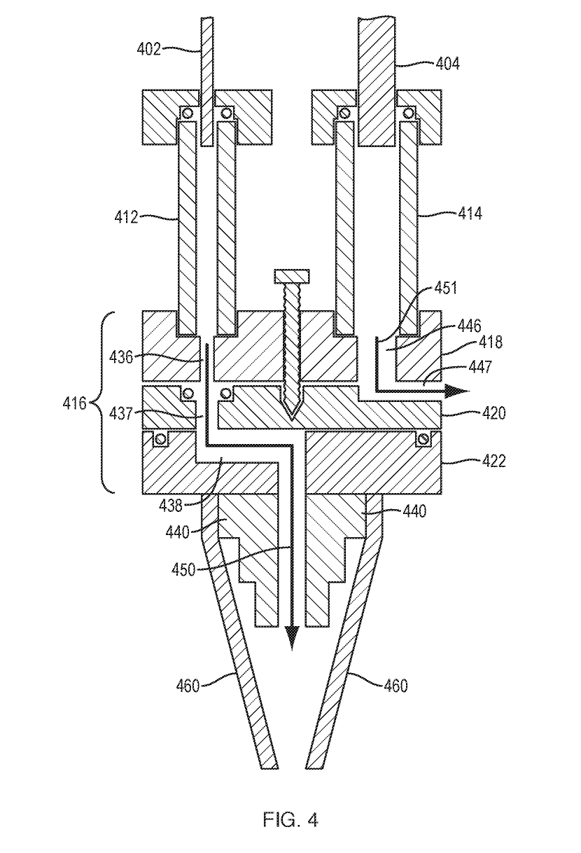

FIG. 4 shows air channels in a pipette, and also shows rotatable components for selecting which cylinder in the pipette has an airway connection to the pipette tip. The pipette includes two pistons 402, 404 and two cylinders 412, 414. A pipette tip 460 fits snugly around an annular portion of attachment site 440 at the bottom of the pipette.

In FIG. 4, a region 416 of the pipette includes an upper component 418, middle component 420 and lower component 422. The upper component 418 fits snugly around ends of cylinders 412, 414. Components 420, 422 are rotatable about the central axis of the pipette. In the example in FIG. 4, components 420, 422 are rotated such that (a) a first airway connects cylinder 412 to the pipette tip 460; and (b) a second airway vents cylinder 414 directly to the ambient air. Line 450 indicates a path that air can travel through the first airway; and line 451 indicates a path that air can travel through the second airway. The first airway comprises channels 436, 437 and 438 in the upper, middle and lower components 418, 422, 422, respectively. The second airway comprises channels 446 and 447 in the upper and middle components 418, 420, respectively.

Thus, in FIG. 4, region 416 includes components 420, 422 that are rotatable about the central axis of the pipette and that are penetrated by airways. The rotational position of components 420, 422 selects which cylinder has an airway connection to the pipette tip and which cylinder has an airway connection that vents directly to the ambient air without passing through a pipette tip.

More generally, in illustrative implementations of this invention, the pipette includes a selection mechanism for selecting which cylinder has an airway connection to the pipette tip and which cylinder(s) have an airway connection that vents directly to the ambient air without passing through a pipette tip. In some cases, the selection mechanism comprises one or more rotatable components that are penetrated by airways (such as components 420, 422 in FIG. 4).

However, many other types of selection mechanisms may be employed.

For example, in some cases the selection mechanism comprises a set of airways, valves and actuators for the valves, wherein opening and closing the valves selects which pipette cylinder is connected by an airway to a pipette tip and which other pipette cylinder(s) vent directly to ambient atmosphere.

In other cases, for example, the selection mechanism comprises one or more components, wherein (a) the components are each penetrated by one or more airways; and (b) the components are configured to move relative to each other, such that in different positions, different airways in the components align with each other and thereby select which pipette cylinder is connected by an airway to a pipette tip and which other pipette cylinder(s) vent directly to ambient atmosphere. For example, the components may slide past each other in a linear motion, or may each rotate about a central axis. In some cases, the lower ends of the cylinders comprise, or are housed in or attached to, one of the components.

In some alternative implementations, the selection mechanism comprises a revolving unit that houses the multiple cylinders and their corresponding pistons. By revolving the revolving unit, different pistons (and thus different cylinders) are aligned with the shaft (similar to how revolving chambers in a revolver pistol causes different chambers to align with the hammer and barrel of the pistol). The shaft is actuated by a motor or by a plunger that is pressed by a user. In this alternative approach: (a) only one piston at a time is aligned with and actuated by the shaft; (b) a single down-stroke of the shaft causes only one of the cylinders to expel air; and (c) the cylinder that expels air is attached by an airway to the pipette tip.

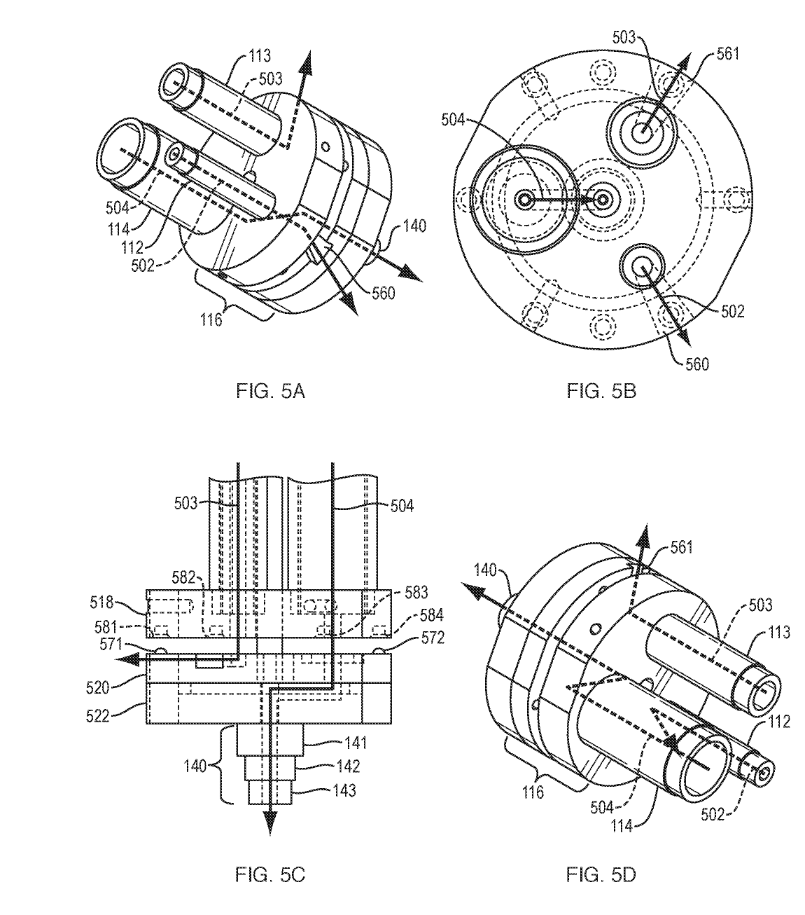

FIGS. 5A, 5B, 5C and 5D each show a different view of a region 116 of a pipette that is penetrated by air channels. Region 116 includes rotatable components.

In the example shown in FIGS. 5A, 5B, 5C and 5D, the rotatable components of region 116 are in rotational positions such that: (a) an airway 504 connects cylinder 114 to a pipette tip (not shown) that fits snugly around attachment site 140; (b) an airway 502 connects cylinder 112 to a hole 560 that opens to the ambient atmosphere; and (c) an airway 503 connects cylinder 113 to a hole 561 that opens to the ambient atmosphere. Thus, in the example shown in FIGS. 5A, 5B, 5C and 5D, cylinder 114 is connected by an airway to a pipette tip (not shown) and cylinders 112 and 113 vent directly to the ambient atmosphere.

The rotatable components are rotatable in discrete “indexable” steps, with each step corresponding to a selection of a cylinder to be connected to the pipette tip. For example, in FIGS. 5A, 5B, 5C and 5D, rotatable component 520 includes flexible bumps 571, 572 that snap into place in holes (e.g., 581, 582, 583, 584). These holes are located in a component 518 that fits snugly around the lower ends of cylinders 112, 113, 114. For example, rotational component 520 may be rotated into a position such that bumps 571, 572 snap into holes 581 and 582, thereby selecting cylinder 114 to have an airway connection to the pipette tip and selecting cylinders 112, 113 to vent directly to the ambient atmosphere via airways that do not pass through attachment site 140. In order to select another cylinder to have an airway connection to a pipette tip, component 520 would be rotated into a different rotational position such that bumps 571, 572 fit into other holes.

FIG. 5E shows an example in which the cylinders each have a different diameter and the airways each have a different diameter.

In some implementations of this invention, different-sized airways tend to equalize air pressure in the different-sized cylinders during a piston downstroke.

In FIG. 5E, cylinders 114, 113, 112 have different minimum cross-sectional areas (MCSAs), as defined herein. The MCSA of cylinder 114 is greater than the MCSA of cylinder 113, which in turn is greater than the MCSA of cylinder 112. Similarly, airways 104, 103, 102 have different MCSAs. The MCSA of airway 504 is greater than the MCSA of airway 503, which in turn is greater than the MCSA of airway 502.

Also, in FIG. 5E, cylinders 114, 113, 112 have diameters 554, 553, 552, respectively. Diameter 554 is greater than diameter 553, which in turn is greater than diameter 552. Likewise, airways 504, 503, 502 have diameters 544, 543, 542, respectively. Diameter 544 is greater than diameter 543, which in turn is greater than diameter 542. In FIG. 5E, the diameters are measured where the minimum cross-sectional area of the cylinder or airway occurs. Alternatively, the diameter shown in FIG. 5E for each airway or cylinder is the minimum diameter that occurs throughout the length of that airway or cylinder.

In some implementations, an airway that connects to a larger cylinder has a larger diameter (or larger MCSA) than an airway that connects to a smaller cylinder (for purposes of this sentence, diameter is measured at an airway's narrowest point).

In FIG. 5E, for clarity of presentation, the diameters and cross-sections of the different cylinders and airways all appear to be in same geometric plane. But, in actuality, they may be in different geometric planes.

### Force Sensing

In some implementations of this invention, a plunger of the pipette is actuated by force applied by a finger (e.g., thumb) of a user. In these implementations, it is advantageous—for at least three reasons—to position a pressure sensor at the top of the plunger.

First, the pressure sensor may detect when a finger is present (i.e., touching the actuator top).

Second, pressure data gathered by the pressure sensor may be used to prevent strain injuries and to adjust the amount of work expended in actuating the pipette for particular tasks. For example, a computer may adjust, based on pressure data gathered by the pressure sensor, the “stiffness” of the pipette—i.e., the amount of pressure expended by a user to actuate the plunger. A computer could make this adjustment to the “stiffness” of the pipette by, among other things, controlling a motor to apply a brake to increase friction that the plunger must overcome.

Third, a computer may detect, based on pressure data gathered by the pressure sensor, which stage of pipetting is occurring. In many cases, there are four stages to a pipetting operation: initial plunging, linear plunging to the stop point, force ejection past the stop point and finally release of the plunger. At each of these phases, the user exerts different amounts of force to the plunger. Being able to detect the stage of pipetting operation: (a) is helpful in standardizing pipetting operations across users; and (b) enables a context-aware pipette system to provide a user with helpful feedback in real time.

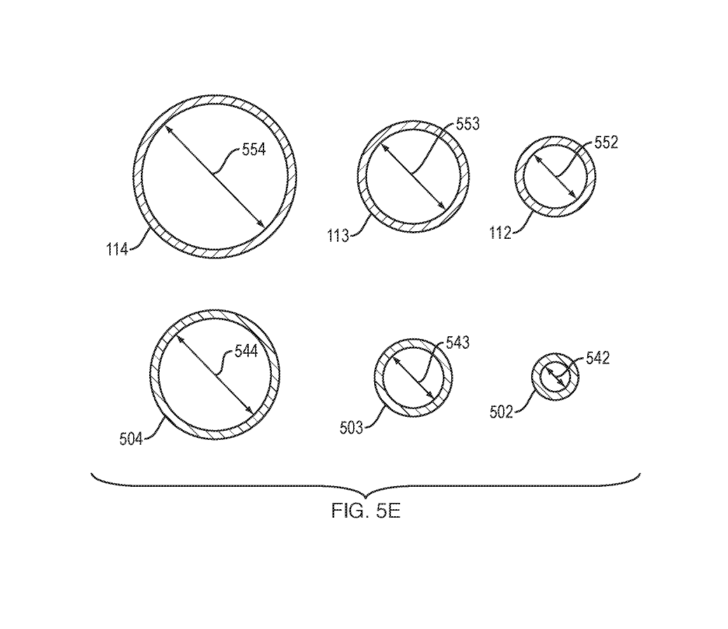

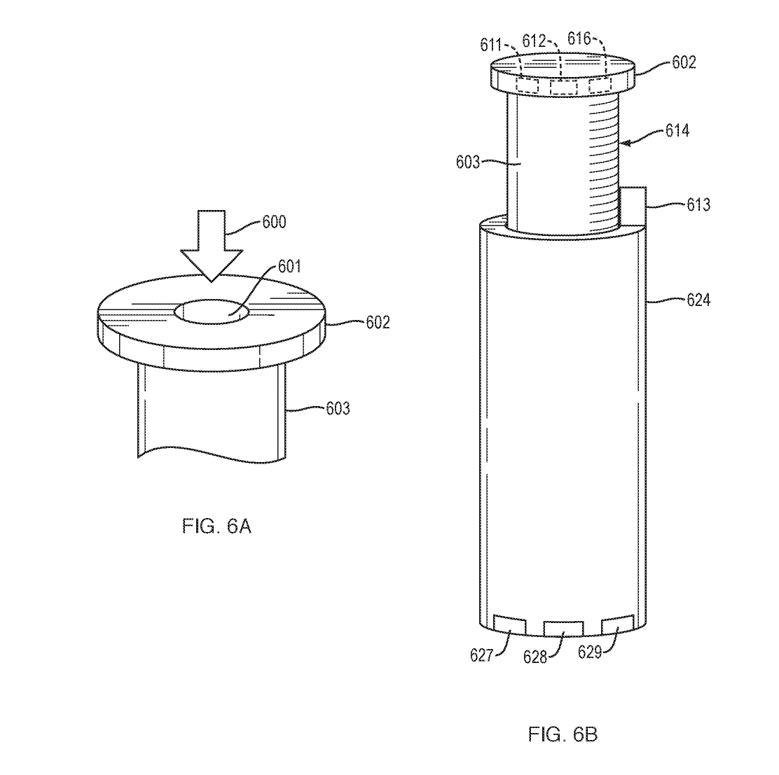

FIG. 6A shows a sensor for detecting pressure exerted against the plunger by a user's thumb. In the example shown in FIG. 6A, a pressure sensor 601 is positioned at the top 602 of a plunger 603 of the pipette. Sensor 601 detects pressure due to a force 600 exerted by a user's finger against the plunger.

### Sensing Speed of Pipetting

In some implementations of this invention, one or more sensors onboard the pipette measure the speed or velocity of pipetting. This has many practical benefits. For example, in some use applications, a computer calculates—based on this measured speed or velocity, and also based on viscosity of the liquid and volume of liquid dispensed—the shear forces that occur in liquid as it is dispensed during the pipetting. The system may provide feedback to the user regarding the amount of shear forces generated, thereby enabling the user to control the amount of shear forces.

For example, large genome transplantation may involve pipetting of liquid with large pieces of DNA—often multiple 10s of kilobases of DNA. These large pieces of DNA break easily when exposed to shear forces. Thus, it is desirable to provide feedback to a user regarding the amount of shear forces being created, to help the user reduce the shear forces and thus the damage to the large pieces of DNA. In some cases, by measuring speed or velocity of the piston head and computing shear forces, the pipette is able to provide this feedback to the user.

In many implementations, all of the pistons and a plunger move together, and thus it is sufficient to measure the velocity of only one of them.

Measuring pipetting speed or velocity may be achieved in multiple ways. First, in some cases, a precision optical encoder detects visual marks on the plunger or on a piston and thereby senses the position of the plunger or piston relative to the rest of the pipette. Second, in some cases, a magnetometer is placed at one end (e.g., base of the cylinder) and a magnet is placed at the other end (e.g., plunger top). The intensity of the magnetic field sensed by the magnetometer varies with distance between the two ends (base of the cylinder and top of the plunger). Third, in some cases, a sonar emitter and detector are positioned in the same configuration described for the magnetometer, and sonar measures distance between the two ends (base of the cylinder and top of the plunger). Fourth, in some cases, position of the plunger top relative to the base of the cylinder is measured by capacitive sensing either in transmission mode or reflection mode. The transmission mode employs two electrodes. The reflection mode employs a single electrode at one end and the capacitance of a user's finger at the other end. In each of these four approaches, a computer calculates change in position over time in order to determine speed or velocity.

FIG. 6B shows examples of sensors that measure speed or velocity of pipetting. In some cases, an optical encoder 613 measures position of the encoder relative to a linear visual scale 614 on an actuator 603 (e.g., a piston or plunger). In other cases, a magnetometer 627 at the base of cylinder 624 measures distance to a magnet 611 at the top of the actuator. In yet other cases, distance between base of the cylinder and top of the actuator is measured by sonar: a sonar emitter 628 at the base of cylinder 624 emits sonar pings that are detected by a sonar receiver 612 at the top of the actuator. In still other cases, capacitive sensing detects position of the top of the actuator. Two electrodes 616, 629 of a transmission mode capacitive sensor may be employed for this purpose. Or, electrode 629 may comprise the single electrode of a reflection mode capacitive sensor and may interact with the capacitance of a user's finger.

### Context Aware System

In illustrative implementations, the pipette is part of a context-aware pipetting system. This context-aware system detects and records in real time the context in which pipetting occurs, including the wells into which liquid is dispensed, the volume of liquid dispensed, ambient conditions (such as temperature, humidity, and lighting), the shear forces generated during dispensing, and the pressure exerted on the plunger top. The context-aware pipette includes I/O devices by which a user may input verbal or written annotations regarding pipetting events, and by which feedback may be provided to the user. The data recorded by the context-aware system may be analyzed to determine correlations between pipetting events, context of the pipetting events, and outcomes.

In some implementations, the context-aware system includes a computer vision system. The computer vision system performs position sensing by detecting and recording in real time the wells into which liquid is dispensed by the pipette. In some cases, the computer vision system: (a) determines the position of the pipette tip by detecting a colored portion of a pipette tip; (b) recognizes individual wells inside well plates; and (c) tracks test tubes.

The computer vision apparatus includes a camera that images a scene in which pipetting occurs. In some cases, the camera streams information to a computer with dedicated graphics capabilities. The computer may be housed with or nearby the camera, or may be remote from the camera.

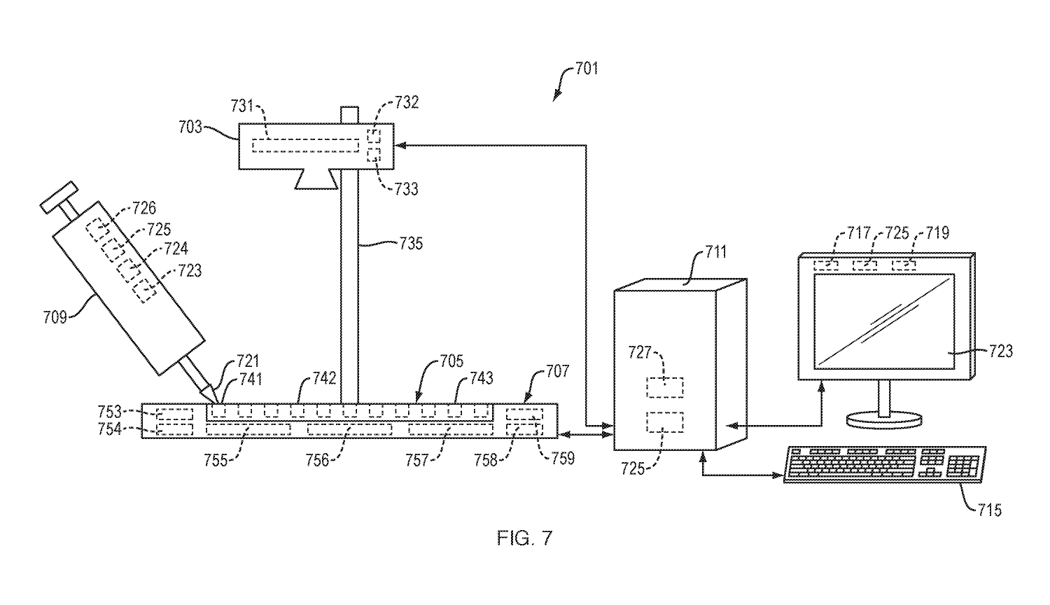

FIG. 7 shows a context-aware pipetting system 701. A well tray 705 includes multiple wells (e.g., 741, 742, 743) for containing liquid dispensed by the pipette. A camera 703 is supported by a support structure 735. The camera is positioned such that the camera has a direct view of tray 705. The camera includes an image sensor 731, a computer 732 and (optionally) a wireless communication module 733. The camera captures images. One or more computers (e.g., 732 and 711) perform algorithms to calculate, based on the images, the position of pipette tip 721, the position of wells in tray 705, and the volume of liquid in each well in tray 705.

One or more sensors are adjacent to, or housed in, well tray 705. For example, in some cases, sensors 753, 754, 755, 757, 758 comprise a combination of one or more temperature sensors, humidity sensors, and light sensors. Optionally, sensors in the well tray communicate wirelessly with a computer 711, via wireless communication module 759.

Computer 711 may be located nearby, or remote from, the rest of the context-aware system. Computer 711 may communicate with other hardware in the system by wired connections and in some cases by a wireless communication device 725. Computer 711 may record data in a memory device 727.

The pipette 709 includes multiple cylinders (not shown in FIG. 7) with different volumes, and also includes airways (not shown in FIG. 7) for connecting a selected cylinder to the pipette tip and for venting the non-selected cylinders. A pipette tip 721 fits snugly around an attachment site at the bottom of the pipette 709. The pipette 709 also includes one or more actuators 723, one or more sensors 724, a computer (e.g., a microcontroller) 725, and a wireless communication module 726. For example, the one or more actuators 723 may actuate motion: (a) that adjusts the position of a mechanical stop; or (b) that adjusts the position of one or more components and thus selects which of the cylinders is connected to the pipette tip; or (c) that drives motion of a shaft connected to pistons of the multi-cylinder pipette.

The context-aware system also includes I/O devices, including in some cases a computer screen 723, a keyboard 715, a microphone 717, a speaker 719, and a camera 728. In some cases, a user employs the I/O devices for inputting annotations regarding pipetting events. For example, a user may orally dictate annotations. This oral dictation may be recorded by microphone 717 and a computer 711 may perform a speech recognition algorithm to recognize what was said in the oral dictation.

Cameras 703, 728 may each comprise a webcam or video camera.

### Volume Sensing

In some cases, the computer vision system measures volume of liquid in each well in a well tray.

In some cases, optical volume sensing is achieved by using fiducials. The fiducials are positioned under the well tray, such that a fiducial is located underneath each well in the tray. For example, an electronic display screen (such as the screen of a smartphone) may display the fiducials. Or, for example, the fiducials may be printed on a sheet of paper that is inserted underneath the well tray. The well tray is transparent or semi-transparent. Liquid in the well refracts light from the fiducial. The apparent size of the fiducial, in an image captured by the camera, depends on the amount of liquid in the well. A camera positioned above the well tray captures images of the well tray. A computer analyzes these images to determine the volume of liquid in each well. For example, a computer may identify a fiducial in an image captured by the camera, and compare the size of that fiducial to calibrated sizes of the visual fiducial in wells with known amounts of liquids.

In other cases, optical volume sensing is achieved without using fiducials. For example: (a) a camera may capture an image of a well tray; and (b) a computer may, based on the image, calculate, for each well in the well tray, the distance from the top of the liquid meniscus to the top of the well. In order to obtain the position of the top of the liquid meniscus, a special camera may be used. This special camera may operate in the non-visible spectrum to enable tracking of the liquid's heat signature.

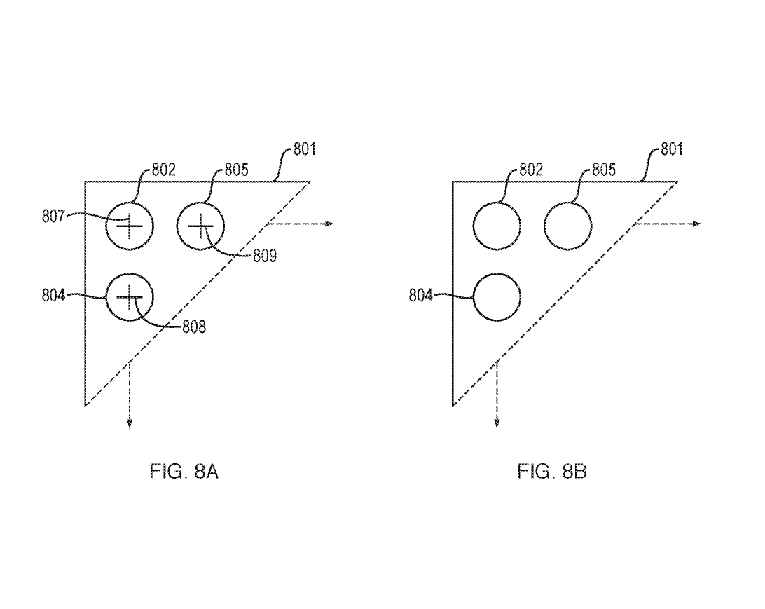

FIGS. 8A and 8B show wells in a portion of a well tray 801. In FIG. 8A, wells 802, 804, 805 are positioned above visual fiducials 807, 808, 809, respectively. In FIG. 8B, wells 802, 804, 805 are not positioned over visual fiducials.

### Position Sensing

In illustrative implementations of this invention, a computer vision system tracks the position of the pipette tip relative to wells in a well tray (or relative to other features in the pipette's environment. The computer vision system comprises a camera (e.g., 703) and one or more computers (e.g., 732, 711).

The position sensing includes two main operations: (a) first, assigning and tracking destinations such as wells in a well plate; and (b) second, tracking the position of the pipette tip.

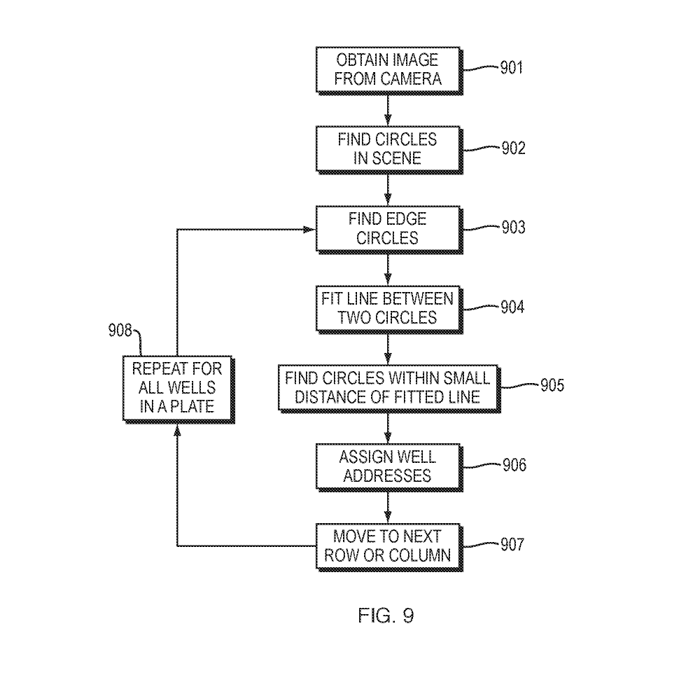

An example algorithm for performing the first operation is shown in FIG. 9. Specifically, FIG. 9 is a flow-chart for steps in a method of assigning addresses to wells in an image of a well plate. The method shown in FIG. 9 is rotation independent. The method includes the following steps: obtain image from camera (step 901); find circle in scene (step 902); find edge circles (step 903); fit line between two circles (step 904); find circles within small distance of fitted line (step 905); assign well addresses (step 906); move to next row or column of the well tray (step 907); and repeat—i.e., go to step 903—until the entire well plate is accounted for (step 908).

In some implementations of this invention, position sensing is performed as follow: A computer analyzes images captured by camera. Based on these images, a computer identifies a rectangular pattern of wells from a well plate, computes the number of detected rows and columns, and calculates the well density of the plate and thus what type of plate it is (e.g., 96-well tray, or 384-well tray). After detecting the presence of a well plate and assigning well addresses, the position sensing algorithm then detects the edge of the pipette tip and identifies the well in which the tip is located. This pipette tip tracking may be performed in different ways, yielding different results and optimizing for different tradeoffs. Different ways of obtaining the position of the tip include: color tracking using a colored tip, using a trained classifier to recognize transparent tips and using fiducials on the tip or the pipette.

### Wireless Communication and Protocol Context-Awareness

In illustrative implementations, the pipette communicates wirelessly with a computer. In some cases, data transmitted wirelessly between the computer and the pipette: (a) causes the pipette to set itself automatically before the user picks up the pipette; and (b) causes the system to provide feedback to the user interactively, regarding detected errors and other protocol and tool relevant cues.

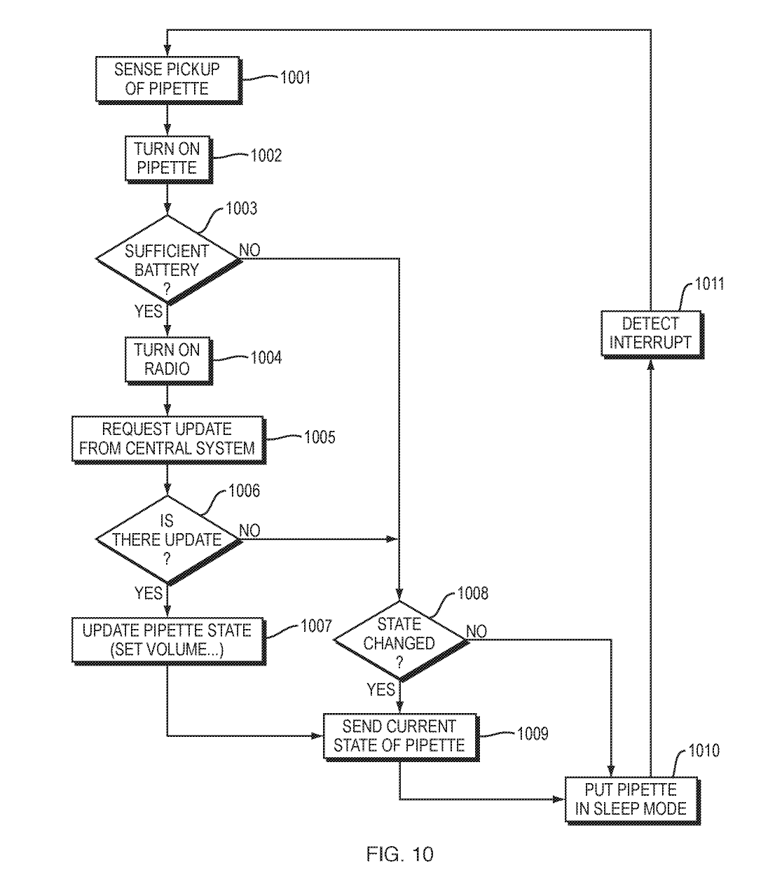

FIG. 10 is a flow-chart for a pipette detecting and reporting its state. The method shown in FIG. 10 includes the following steps: sense pickup of pipette (step 1001); turn on pipette (step 1002); determine if sufficient battery, if yes go to step 1004, if no go to step 1008 (step 1003); turn on radio (step 1004); request update from central system (step 1005); determine if there is an update, if yes go to step 1007, if no go to step 1008 (step 1006); update pipette state (step 1007); determine if state changes, if yes go to step 1009, if no go to step 1010 (step 1008); send current state of pipette (step 1009); put pipette in sleep mode (step 1010); detect interrupt (step 1011). When the interrupt is detected, the method repeats by returning to step 1001.

### Feedback

In illustrative implementations of this invention, feedback from sensors affects the operation of the pipette.

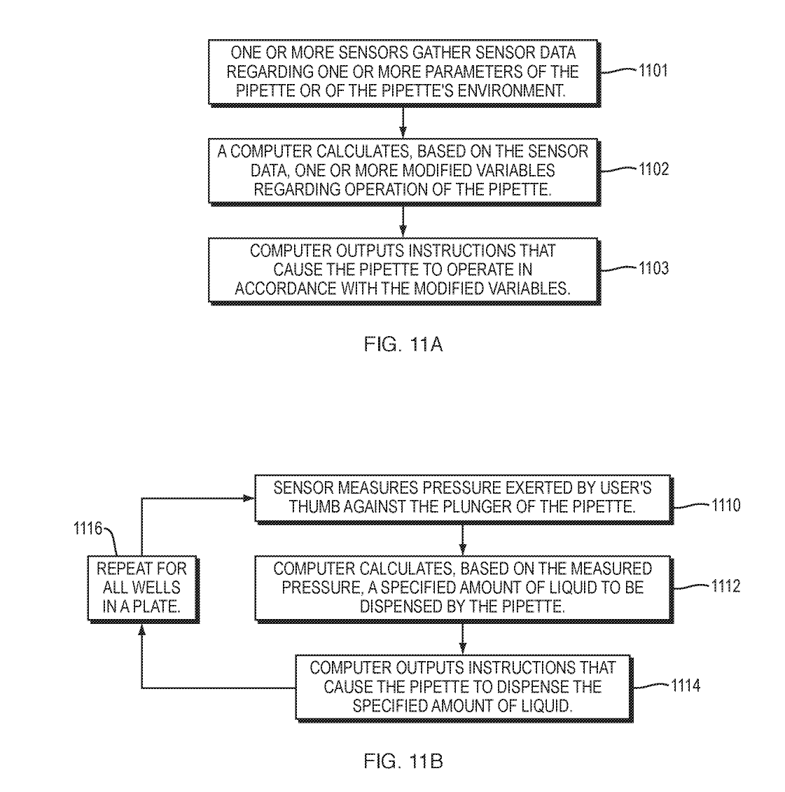

FIG. 11A is a flow-chart for a sensor providing feedback to a pipette. The method shown in FIG. 11A includes the following steps: One or more sensors gather sensor data regarding one or more parameters of the pipette or of the pipette's environment (step 1101). A computer calculates, based on the sensor data, one or more modified variables regarding operation of the pipette (step 1102). A computer outputs instructions that cause the pipette to operate in accordance with the modified variables (step 1103).

FIG. 11B is a flow-chart for a pressure sensor providing feedback to a pipette. The method shown in FIG. 11B includes the following steps: A sensor measures pressure exerted by user's thumb against the plunger of the pipette (step 1110). A computer calculates, based on the measured pressure, a specified amount of liquid to be dispensed by the pipette (step 1112). The computer outputs instructions that cause the pipette to dispense the specified amount of liquid (step 1114). Repeat for all wells in a plate (step 1116).

### Computers

In exemplary implementations of this invention, one or more electronic computers (e.g. 711, 732) are programmed and specially adapted: (1) to control the operation of, or interface with, hardware components of a multi-cylinder pipette, including one or more actuators for actuating components of the pipette (such as a mechanical stop, a rotatable disk for selection of airways, or another mechanism for selection of airways) and including sensors (e.g., a pressure sensor, linear encoder, magnetometer or sonar) for sensing parameters of the pipette or of operation of the pipette or of fluid in the pipette; (2) to control the operation of, or interface with, a wireless communication module; (3) to control the operation of, or interface with, I/O devices, including any microphone, speaker, camera, keyboard, computer mouse, display screen, or capacitive touch screen, (4) to control the operation of, or interface with, one or more cameras; (5) to control the operation of, or interface with, one or more other sensors (e.g., a temperature sensor, humidity sensor, or light sensor); (6) to perform image processing, image analysis or computer vision algorithms, including algorithms for position sensing and volume sensing; (7) to perform any other calculation, computation, program, algorithm, or computer function described or implied above; (8) to receive signals indicative of human input; (9) to output signals for controlling transducers for outputting information in human perceivable format; and (10) to process data, to perform computations, to execute any algorithm or software, and to control the read or write of data to and from memory devices (items 1-10 of this sentence referred to herein as the “Computer Tasks”). The one or more computers may be in any position or positions within or outside of the pipette. For example, in some cases (a) at least one computer is housed in or together with other components of the pipette, and (b) at least one computer is remote from other components of the pipette. The one or more computers communicate with each other or with other components of the context-aware pipetting system either: (a) wirelessly, (b) by wired connection, (c) by fiber-optic link, or (d) by a combination of wired, wireless or fiber optic links.

In exemplary implementations, one or more computers are programmed to perform any and all calculations, computations, programs, algorithms, computer functions and computer tasks described or implied above. For example, in some cases: (a) a machine-accessible medium has instructions encoded thereon that specify steps in a software program; and (b) the computer accesses the instructions encoded on the machine-accessible medium, in order to determine steps to execute in the program. In exemplary implementations, the machine-accessible medium comprises a tangible non-transitory medium. In some cases, the machine-accessible medium comprises (a) a memory unit or (b) an auxiliary memory storage device. For example, in some cases, a control unit in a computer fetches the instructions from memory.

In illustrative implementations, one or more computers execute programs according to instructions encoded in one or more tangible, non-transitory, computer-readable media. For example, in some cases, these instructions comprise instructions for a computer to perform any calculation, computation, program, algorithm, or computer function described or implied above. For example, in some cases, instructions encoded in a tangible, non-transitory, computer-accessible medium comprise instructions for a computer to perform the Computer Tasks.

### Network Communication

In illustrative implementations of this invention, an electronic device (e.g., 703, 709) is configured for wireless or wired communication with other electronic devices in a network.

For example, in some cases, a computer 111, a pipette 703 and a digital camera 703 each include a wireless communication module for wireless communication with other electronic devices in a network. Each wireless communication module (e.g., 726, 733, 759) includes (a) one or more antennas, (b) one or more wireless transceivers, transmitters or receivers, and (c) signal processing circuitry. The wireless communication module receives and transmits data in accordance with one or more wireless standards.

In some cases, one or more of the following hardware components are used for network communication: a computer bus, a computer port, network connection, network interface device, host adapter, wireless module, wireless card, signal processor, modem, router, computer port, cables or wiring.

In some cases, one or more computers (e.g., 711, 732) are programmed for communication over a network. For example, in some cases, one or more computers are programmed for network communication: (a) in accordance with the Internet Protocol Suite, or (b) in accordance with any other industry standard for communication, including any USB standard, ethernet standard (e.g., IEEE 802.3), token ring standard (e.g., IEEE 802.5), wireless standard (including IEEE 802.11 (wi-fi), IEEE 802.15 (bluetooth/zigbee), IEEE 802.16, IEEE 802.20 and including any mobile phone standard, including GSM (global system for mobile communications), UMTS (universal mobile telecommunication system), CDMA (code division multiple access, including IS-95, IS-2000, and WCDMA), or LTS (long term evolution)), or other IEEE communication standard.

### Actuators

In illustrative implementations, the pipette includes actuators. For example, in some cases, one or more actuators actuate motion: (a) that adjusts the position of a mechanical stop; or (b) that adjusts the rotational position of a component and thus selects which of the cylinders is connected to the pipette tip; or (c) that drives motion of a shaft connected to pistons of the multi-cylinder pipette

In illustrative implementations, each actuator (including each actuator for actuating any movement) is any kind of actuator, including a linear, rotary, electrical, piezoelectric, electro-active polymer, mechanical or electro-mechanical actuator. In some cases, the actuator includes and is powered by an electrical motor, including any stepper motor or servomotor. In some cases, the actuator includes a gear assembly, drive train, pivot, joint, rod, arm, or other component for transmitting motion. In some cases, one or more sensors are used to detect position, displacement or other data for feedback to one of more of the actuators.

### Definitions

The terms “a” and “an”, when modifying a noun, do not imply that only one of the noun exists.

To say that X “actuates” Y does not require that X be in direct contact with Y. As a non-limiting example, a motor that transmits force through a shaft to cause a piston to move “actuates” the piston, even though the motor does not touch the piston.

An “airway” means a channel through which gas flows.

“Ambient atmosphere”, in the context of a pipette, means atmosphere that is external to the pipette.

To compute “based on” specified data means to perform a computation that takes the specified data as an input.

Non-limiting examples of a “camera” include: (a) a digital camera; (b) a digital grayscale camera; (c) a digital color camera; and (d) a video camera

The term “comprise” (and grammatical variations thereof) shall be construed as if followed by “without limitation”. If A comprises B, then A includes B and may include other things.

The term “computer” includes any computational device that performs logical and arithmetic operations. For example, in some cases, a “computer” comprises an electronic computational device, such as an integrated circuit, a microprocessor, a mobile computing device, a laptop computer, a tablet computer, a personal computer, or a mainframe computer. In some cases, a “computer” comprises: (a) a central processing unit, (b) an ALU (arithmetic logic unit), (c) a memory unit, and (d) a control unit that controls actions of other components of the computer so that encoded steps of a program are executed in a sequence. In some cases, a “computer” also includes peripheral units including an auxiliary memory storage device (e.g., a disk drive or flash memory), or includes signal processing circuitry. However, a human is not a “computer”, as that term is used herein.

To say that a X is “connected by an airway” to Y means that the airway forms a passage for air to flow from X to Y or from Y to X. To say that X is “connected to an airway” means that a channel or aperture forms a passage for air to flow from X to the airway or from the airway to X.

To “contain” a material (such as air) means to limit the range of motion of the material at least to some extent. For example, a pipe that has two open ends and that has air inside the pipe “contains” air, even though air may enter or exit the pipe at either end of the pipe.

“Cross-sectional area” of a container, such as an airway or cylinder, means an area that (a) is bounded by inner surface of the container and (b) lies entirely in a geometric plane that is a cross-section of the container.

“Defined Term” means a term or phrase that is set forth in quotation marks in this Definitions section.

“Down” means, in the context of a pipette, the direction in which a piston of the pipette moves when expelling material from, or compressing material in, a cylinder of the pipette. Other directional terms (such as “downward”, “lower”, “bottom”, “top” and “up”) shall, in the context of a pipette, be construed consistently with the preceding sentence.

The “diameter” of a cylinder means the inner wall-to-inner wall diameter of the cavity of the cylinder.

For an event to occur “during” a time period, it is not necessary that the event occur throughout the entire time period. For example, an event that occurs during only a portion of a given time period occurs “during” the given time period.

The term “e.g.” means for example.

The fact that an “example” or multiple examples of something are given does not imply that they are the only instances of that thing. An example (or a group of examples) is merely a non-exhaustive and non-limiting illustration.

Unless the context clearly indicates otherwise: (1) a phrase that includes “a first” thing and “a second” thing does not imply an order of the two things (or that there are only two of the things); and (2) such a phrase is simply a way of identifying the two things, respectively, so that they each may be referred to later with specificity (e.g., by referring to “the first” thing and “the second” thing later). For example, unless the context clearly indicates otherwise, if an equation has a first term and a second term, then the equation may (or may not) have more than two terms, and the first term may occur before or after the second term in the equation. A phrase that includes a “third” thing, a “fourth” thing and so on shall be construed in like manner.

“Fluid” means a gas or a liquid.

“For instance” means for example.

“Herein” means in this document, including text, specification, claims, abstract, and drawings.

As used herein: (1) “implementation” means an implementation of this invention; (2) “embodiment” means an embodiment of this invention; (3) “case” means an implementation of this invention; and (4) “use scenario” means a use scenario of this invention.

The term “include” (and grammatical variations thereof) shall be construed as if followed by “without limitation”.

“I/O device” means an input/output device. Non-limiting examples of an I/O device include any device for (a) receiving input from a human user, (b) providing output to a human user, or (c) both. Non-limiting examples of an I/O device also include a touch screen, other electronic display screen, keyboard, mouse, microphone, handheld electronic game controller, digital stylus, display screen, speaker, or projector for projecting a visual display.

“Light” means electromagnetic radiation of any frequency. For example, “light” includes, among other things, visible light and infrared light. Likewise, any term that directly or indirectly relates to light (e.g., “imaging”) shall be construed broadly as applying to electromagnetic radiation of any frequency.

“Minimum cross-sectional area” (or “MCSA”) of a container, such as an airway or cylinder, means the smallest cross-sectional area of the container that occurs in any cross-section of the container.

The term “or” is inclusive, not exclusive. For example, A or B is true if A is true, or B is true, or both A or B are true. Also, for example, a calculation of A or B means a calculation of A, or a calculation of B, or a calculation of A and B.

A parenthesis is simply to make text easier to read, by indicating a grouping of words. A parenthesis does not mean that the parenthetical material is optional or may be ignored.

A “pipette tip” means a channel that (i) is attachable to and detachable from the pipette, and (ii) includes an aperture that, when the pipette tip is attached to the pipette, opens directly into a material (such as atmosphere or liquid in a well) external to the pipette.

As used herein, the term “set” does not include a group with no elements. Mentioning a first set and a second set does not, in and of itself, create any implication regarding whether or not the first and second sets overlap (that is, intersect).

“Some” means one or more.

“Spoke” means a radial structural element.

As used herein, a “subset” of a set consists of less than all of the elements of the set.

To say that quantities are “substantially”equal to each other means that each of the quantities differs from each of the other quantities by ten percent or less.

The term “such as” means for example.

To say that a machine-readable medium is “transitory” means that the medium is a transitory signal, such as an electromagnetic wave.

As used herein, “work” means energy, that is, force times distance. The SI unit of work is a joule.

Except to the extent that the context clearly requires otherwise, if steps in a method are described herein, then the method includes variations in which: (1) steps in the method occur in any order or sequence, including any order or sequence different than that described; (2) any step or steps in the method occurs more than once; (3) different steps, out of the steps in the method, occur a different number of times during the method, (4) any combination of steps in the method is done in parallel or serially; (5) any step or steps in the method is performed iteratively; (6) a given step in the method is applied to the same thing each time that the given step occurs or is applied to different things each time that the given step occurs; or (7) the method includes other steps, in addition to the steps described.

This Definitions section shall, in all cases, control over and override any other definition of the Defined Terms. For example, the definitions of Defined Terms set forth in this Definitions section override common usage or any external dictionary. If a given term is explicitly or implicitly defined in this document, then that definition shall be controlling, and shall override any definition of the given term arising from any source (e.g., a dictionary or common usage) that is external to this document. If this document provides clarification regarding the meaning of a particular term, then that clarification shall, to the extent applicable, override any definition of the given term arising from any source (e.g., a dictionary or common usage) that is external to this document. To the extent that any term or phrase is defined or clarified herein, such definition or clarification applies to any grammatical variation of such term or phrase, taking into account the difference in grammatical form. For example, the grammatical variations include noun, verb, participle, adjective, and possessive forms, and different declensions, and different tenses. In each case described in this paragraph, the Applicant or Applicants are acting as his, her, its or their own lexicographer.

### Variations

This invention may be implemented in many different ways. Here are some non-limiting examples:

In some implementations, this invention is a pipette that comprises: (a) a set of multiple cylinders, in which each cylinder has a diameter that is different than the diameter of each other cylinder; (b) multiple pistons; (c) a shaft that is configured to move the multiple pistons simultaneously, such that each piston moves within a cylinder, and (d) a selection mechanism for selecting which cylinder is connected by an airway to a pipette tip and which other cylinders are connected by an airway to ambient atmosphere by a path that does not pass through a pipette tip. In some cases: (a) the cylinders are configured to contain air; and (b) the pipette is configured such that, when the pistons move down, the volume of air displaced from each cylinder is different than the volume of air displaced from each other cylinder. In some cases, the selection mechanism is configured to be positioned in a set of discrete positions, such that: (a) at all of the discrete positions, the multiple cylinders are connected to a set of multiple airways, one airway per cylinder; and (b) which cylinder is connected to which airway varies from position to position in the set of discrete positions. In some cases, at each different position in the set of discrete positions, only one cylinder in the pipette is connected by an airway to a pipette tip. In some cases, at each different position in the set of discrete positions: (a) each airway, in the set of airways, has a different minimum cross-sectional area than the minimum cross-sectional area of any other airway in the set of airways; and (b) when the pistons move down, the different minimum cross-sectional areas of the airways, in the set of airways, tend to equalize air pressure in the multiple cylinders. In some cases, the pipette includes a linkage system that, when the pistons move down, transmits force from the shaft to the multiple pistons, in such a manner that the force is distributed unequally among the multiple pistons. In some cases: (a) the pipette system includes a linkage system for transmitting force from the shaft to the pistons; (b) the linkage system includes spokes of unequal lengths, each spoke being attached to the shaft and to a piston; (c) when the shaft moves down, each respective piston applies a torque against the spoke to which the respective piston is attached; and (d) the lengths of the spokes are such that, when the shaft moves down, the magnitudes of the torques applied by the respective pistons are substantially equal to each other. In some cases: (a) the pipette system includes concentric rings for transmitting force to the multiple pistons; and (b) when the shaft moves down (i) each ring transmits force to only one of the pistons, and (ii) the concentric rings, taken together, transmit force from the shaft to all of the pistons. In some cases, the pipette includes a plunger that is configured to be moved by force applied by a user's finger, such that the plunger in turn actuates movement of the pistons. In some cases, the pipette includes one or more sensors for gathering sensor data indicative of speed of a piston. In some cases, the pipette is configured to output the sensor data to a computer that is programmed to calculate, based on the sensor data, one or more shear forces. Each of the cases described above in this paragraph is an example of the pipette described in the first sentence of this paragraph, and is also an example of an embodiment of this invention that may be combined with other embodiments of this invention.

In some implementations, this invention is a system comprising: (a) a pipette that includes (i) multiple cylinders, wherein each cylinder has a minimum cross-sectional area that is different than the minimum cross-sectional area of each other cylinder, (ii) multiple pistons, and (iii) a shaft that is configured to move the multiple pistons; (b) a camera for capturing images of a well tray and of a pipette tip that is attached to the pipette; and (c) one or more computers programmed (i) to calculate, based on the images, position of the pipette tip at different times, and (ii) to identify and record multiple events, wherein each event comprises the pipette dispensing liquid into a specific well in the well tray at a specific time. In some cases, the one or more computers are programmed to calculate, based on the images, volume of liquid in wells in the well tray. In some cases, the system includes one or more I/O devices for accepting input from a user, which input comprises annotations regarding one or more pipetting events. In some cases: (a) the system includes one or more sensors, in addition to the camera, for gathering sensor data; and (b) the one or more computers are programmed to compute, based on the sensor data, an adjustment to the pipette. In some cases: (a) the system includes a pressure sensor for gathering sensor data indicative of pressure exerted by a user's finger on a plunger of the pipette; and (b) the one or more computers are programmed to compute, based on the sensor data indicative of pressure, an adjustment to the pipette, which adjustment controls amount of work performed when moving the shaft down. Each of the cases described above in this paragraph is an example of the system described in the first sentence of this paragraph, and is also an example of an embodiment of this invention that may be combined with other embodiments of this invention.

In some implementations, this invention is a method comprising a single shaft of a pipette moving downward, and thereby causing multiple pistons of the pipette to move downward simultaneously in multiple cylinders of the pipette; wherein the pipette includes a selection mechanism for selecting which cylinder is connected by an airway to a pipette tip and which other cylinders are connected by an airway to ambient atmosphere by a path that does not pass through a pipette tip. In some cases, the method further comprises: (a) a camera capturing images of a well tray and of a pipette tip; and (b) one or more computers (i) calculating, based on the images, position of the pipette tip at different times, and (ii) identifying and recording multiple events, wherein each event comprises the pipette dispensing liquid into a specific well in the well tray at a specific time. In some cases, the one or more computers are programmed to calculate, based on the images, volume of liquid in wells in the well tray. In some cases, the method includes: (a) one or more sensors, in addition to the camera, gathering sensor data; and (b) one or more computers computing, based on the sensor data, an adjustment to the pipette. Each of the cases described above in this paragraph is an example of the method described in the first sentence of this paragraph, and is also an example of an embodiment of this invention that may be combined with other embodiments of this invention.

The above description (including without limitation any attached drawings and figures) describes illustrative implementations of the invention. However, the invention may be implemented in other ways. The methods and apparatus which are described above are merely illustrative applications of the principles of the invention. Other arrangements, methods, modifications, and substitutions by one of ordinary skill in the art are therefore also within the scope of the present invention. Numerous modifications may be made by those skilled in the art without departing from the scope of the invention. Also, this invention includes without limitation each combination and permutation of one or more of the abovementioned implementations, embodiments and features.

What is claimed is:

1. A pipette that comprises:
(a) a set of multiple cylinders, in which each cylinder has a diameter that is different than the diameter of each other cylinder;
(b) multiple pistons;
(c) a shaft that is configured to move the multiple pistons simultaneously, such that each piston moves within a cylinder, and (d) a selection mechanism for selecting which cylinder is connected by an airway to a pipette tip and which other cylinders are connected by an airway to ambient atmosphere by a path that does not pass through a pipette tip.

2. The pipette of claim 1, wherein:
(a) the cylinders are configured to contain air; and
(b) the pipette is configured such that, when the pistons move down, the volume of air displaced from each cylinder is different than the volume of air displaced from each other cylinder.

3. The pipette of claim 1, wherein the selection mechanism is configured to be positioned in a set of discrete positions, such that:
(a) at all of the discrete positions, the multiple cylinders are connected to a set of multiple airways, one airway per cylinder; and
(b) which cylinder is connected to which airway varies from position to position in the set of discrete positions.

4. The pipette of claim 3, wherein at each different position in the set of discrete positions, only one cylinder in the pipette is connected by an airway to a pipette tip.

5. The pipette of claim 3, wherein at each different position in the set of discrete positions:
(a) each airway, in the set of airways, has a different minimum cross-sectional area than the minimum cross-sectional area of any other airway in the set of airways; and
(b) when the pistons move down, the different minimum cross-sectional areas of the airways tend to equalize air pressure in the multiple cylinders.

6. The pipette of claim 1, wherein the pipette includes a linkage system that, when the pistons move down, transmits force from the shaft to the multiple pistons, in such a manner that the force is distributed unequally among the multiple pistons.

7. The pipette of claim 1, wherein:
(a) the pipette system includes a linkage system for transmitting force from the shaft to the pistons;
(b) the linkage system includes spokes of unequal lengths, each spoke being attached to the shaft and to a piston;
(c) when the shaft moves down, each respective piston applies a torque against the spoke to which the respective piston is attached; and
(d) the lengths of the spokes are such that, when the shaft moves down, the magnitudes of the torques applied by the respective pistons are substantially equal to each other.

8. The pipette of claim 1, wherein:
(a) the pipette system includes concentric rings for transmitting force to the multiple pistons; and
(b) when the shaft moves down
(i) each ring transmits force to only one of the pistons, and
(ii) the concentric rings, taken together, transmit force from the shaft to all of the pistons.

9. The pipette of claim 1, wherein the pipette includes a plunger that is configured to be moved by force applied by a user's finger, such that the plunger in turn actuates movement of the pistons.

10. The pipette of claim 9, wherein the pipette includes one or more sensors for gathering sensor data indicative of speed of a piston.

11. The pipette of claim 10, wherein the pipette is configured to output the sensor data to a computer that is programmed to calculate, based on the sensor data, one or more shear forces.

12. A system comprising:
(a) a pipette that includes
(i) multiple cylinders, wherein each cylinder has a minimum cross-sectional area that is different than the minimum cross-sectional area of each other cylinder,
(ii) multiple pistons, and
(iii) a shaft that is configured to move the multiple pistons;
(b) a camera for capturing images of a well tray and of a pipette tip that is attached to the pipette; and
(c) one or more computers programmed
(i) to calculate, based on the images, position of the pipette tip at different times, and
(ii) to identify and record multiple events, wherein each event comprises the pipette dispensing liquid into a specific well in the well tray at a specific time.

13. The system of claim 12, wherein the one or more computers are programmed to calculate, based on the images, volume of liquid in wells in the well tray.

14. The system of claim 12, wherein the system includes one or more I/O devices for accepting input from a user, which input comprises annotations regarding one or more pipetting events.

15. The system of claim 12, wherein:
(a) the system includes one or more sensors, in addition to the camera, for gathering sensor data; and
(b) the one or more computers are programmed to compute, based on the sensor data, an adjustment to the pipette.

16. The system of claim 12, wherein:
(a) the system includes a pressure sensor for gathering sensor data indicative of pressure exerted by a user's finger on a plunger of the pipette; and
(b) the one or more computers are programmed to compute, based on the sensor data indicative of pressure, an adjustment to the pipette, which adjustment controls amount of work performed when moving the shaft down.

17. A method comprising a single shaft of a pipette moving downward, and thereby causing multiple pistons of the pipette to move downward simultaneously in multiple cylinders of the pipette;
wherein the pipette includes a selection mechanism for selecting which cylinder is connected by an airway to a pipette tip and which other cylinders are connected by an airway to ambient atmosphere by a path that does not pass through a pipette tip.

18. The method of claim 17, wherein the method further comprises
(a) a camera capturing images of a well tray and of a pipette tip; and
(b) one or more computers
(i) calculating, based on the images, position of the pipette tip at different times, and
(ii) identifying and recording multiple events, wherein each event comprises the pipette dispensing liquid into a specific well in the well tray at a specific time.

19. The method of claim 17, wherein the one or more computers are programmed to calculate, based on the images, volume of liquid in wells in the well tray.

20. The method of claim 17, wherein the method includes
(a) one or more sensors, in addition to the camera, gathering sensor data; and
(b) one or more computers computing, based on the sensor data, an adjustment to the pipette.
